(19) United States
(12) Patent Application Publication
(10) Pub. No.: US 2015/0216157 A1
(43) Pub. Date: Aug. 6, 2015

(54) RIG SUPPORT FOR TROLL FISHING

(71) Applicant: Michael Todd Flanagan, Brighton, TN (US)

(72) Inventor: Michael Todd Flanagan, Brighton, TN (US)

(21) Appl. No.: 14/611,541

(22) Filed: Feb. 2, 2015

Related U.S. Application Data
(60) Provisional application No. 61/965,550, filed on Feb. 3, 2014.
(60) Provisional application No. 62/006,983, filed on Jun. 3, 2014.

(51) Int. Cl. A01K 97/10; A01K 91/18; F16M 13/02; A01K 91/053

(52) U.S. Cl. CPC A01K 97/10; A01K 91/053; A01K 91/18; F16M 13/02

(57) ABSTRACT

A fishing rod support platform comprising a central portion, a generally arcuate end, a plurality of fishing rod holder-mounting apertures spaced angularly at the generally arcuate end of the platform, and a pedestal-mounting aperture at the central portion of the platform to secure the platform to a pedestal.

### REFERENCE TO RELATED APPLICATIONS

This application claims priority to U.S. provisional applications 61/965,550 filed Feb. 3, 2014 and 62/006,983 filed Jun. 3, 2014, the entire disclosures of which are expressly incorporated herein by reference.

### FIELD OF THE INVENTION

Aspects of the present invention pertain generally to fishing rod holders and more particularly to a fishing rod support system allowing fishing rods to be supported in an array of user-selectable positions.

### BACKGROUND AND SUMMARY

One common method of fishing is trolling. In one type of trolling, a floating vessel (e.g., a boat) moves slowly through the water while one and often several fishing lines (e.g., outriggers and/or downriggers) extend into the water. In this type of trolling, it can be desirable to have many fishing lines in the water at the same time. Conventionally, fishing rods that hold fishing line are mounted to one or more positions on a boat. However, when attempting to troll with multiple fishing poles, it is difficult to prevent the lines from becoming entangled. Moreover, it can be difficult to position the lines to avoid obstacles on the boat (e.g., an outboard motor, etc.) and in the environment (e.g., low-hanging branches, etc.).

An embodiment of the present invention includes a fishing rod support system that enables users to selectively position one or more rods in a desired position.

Another embodiment of the present invention includes a platform that can be secured to a mounting bracket of a pedestal or other support surface and has angularly spaced mounting apertures for receiving a fastener for fastening a rod holder in a desired angular position.

Another embodiment of present invention includes are semiannular rod holder that can be selectively secured to a support surface at a desired angle with respect thereto.

Still another embodiment of the present invention includes a method of making a semiannular rod holder.

Other embodiments and aspects of the present invention will be in part pointed out and in part made apparent in the following description, claims, and drawings.

### BRIEF DESCRIPTION OF THE DRAWINGS

FIG. 1 is a perspective of an embodiment of the fishing rod support system;

FIG. 2 is a top plan of the system;

FIG. 3 is a bottom plan of the system;

FIG. 4 is a rear elevation of the system;

FIG. 5 is a front elevation of the system;

FIG. 6 is a right side elevation of the system;

FIG. 7 is a left side elevation of the system;

FIG. 8 is an alternative perspective view showing the system in the environment of being assembled with bolts onto a standard fishing boat seat pedestal; and

FIG. 9 is a perspective of an embodiment of a fishing rod holder.

Corresponding features are given corresponding reference numbers throughout the description and drawings.

### DETAILED DESCRIPTION

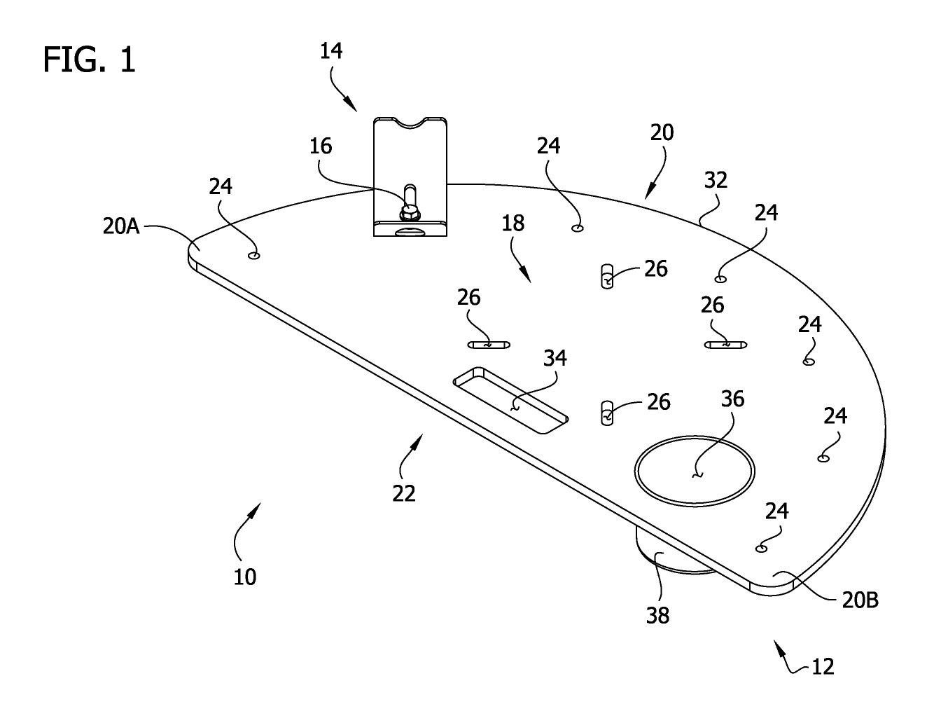

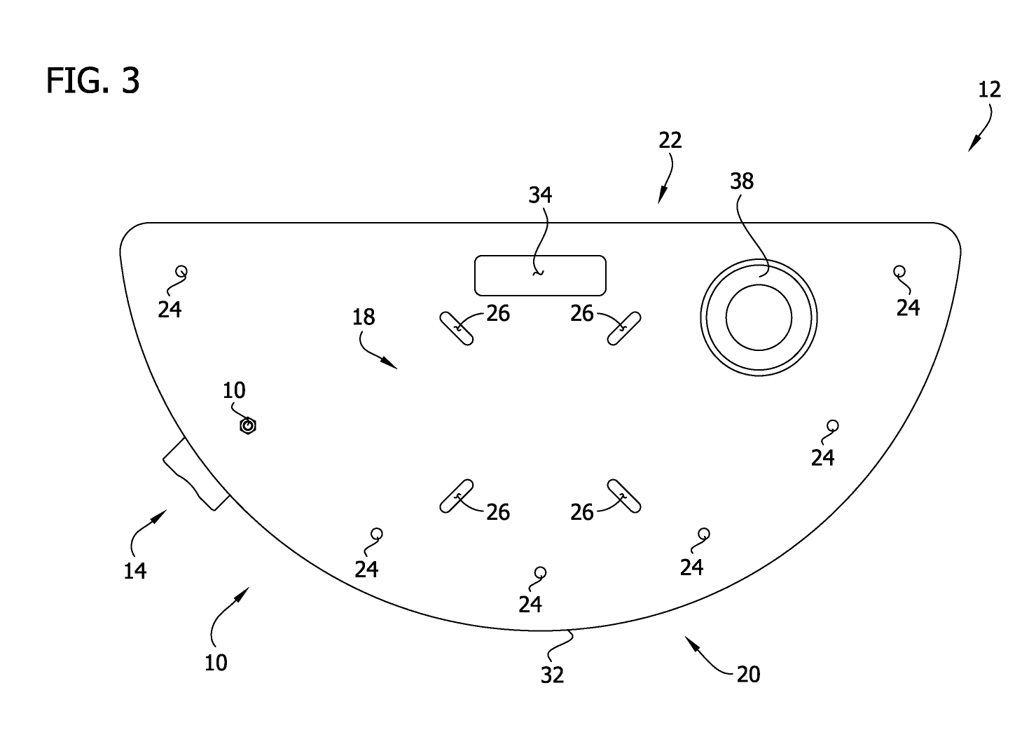

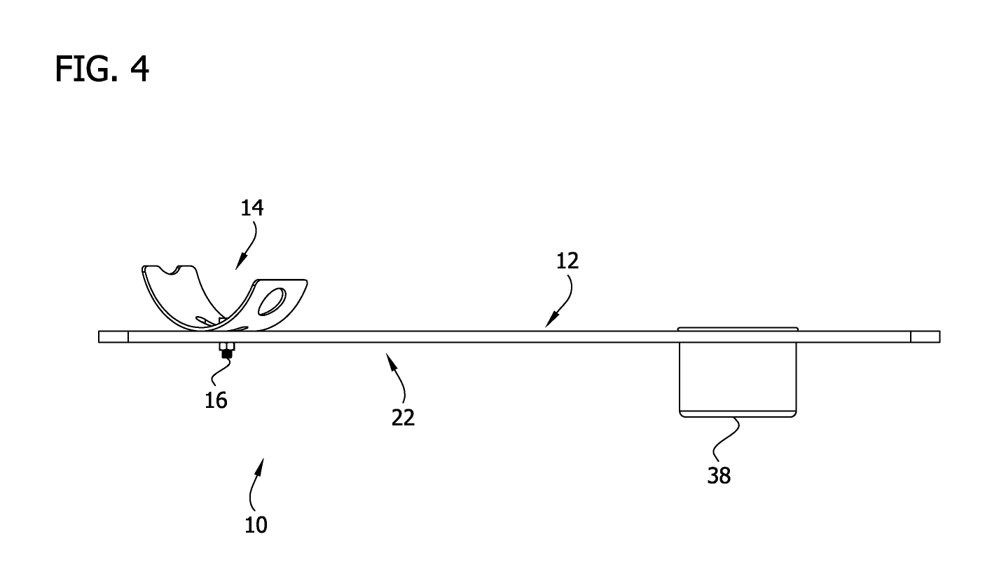

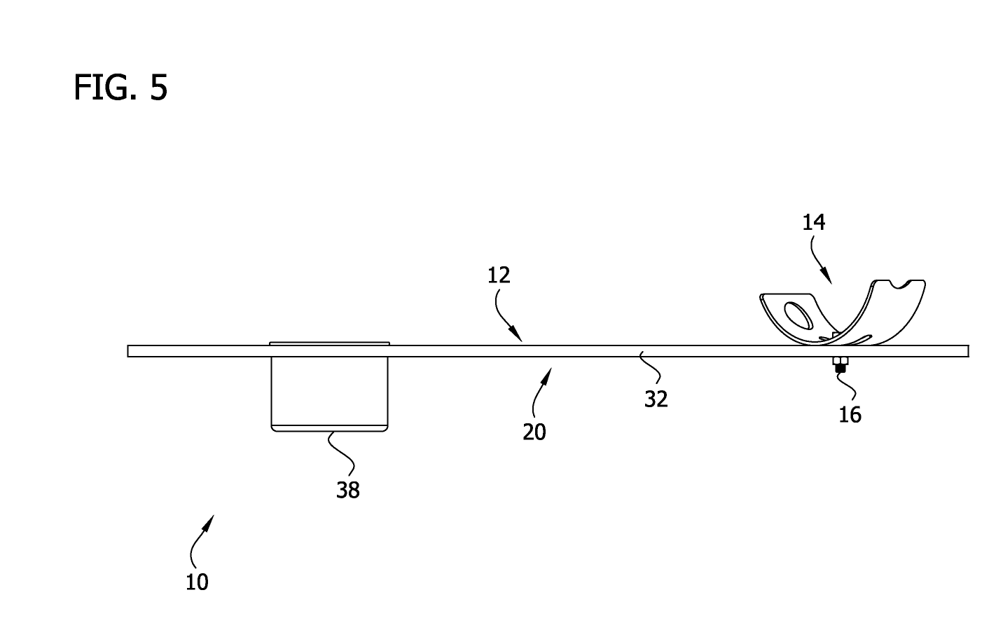

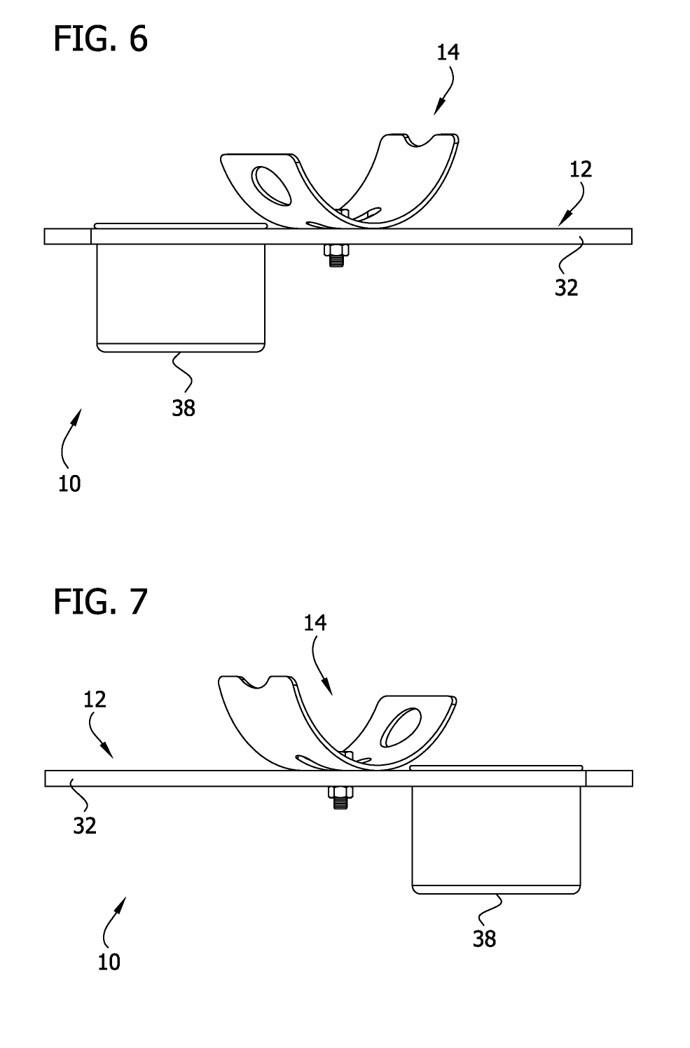

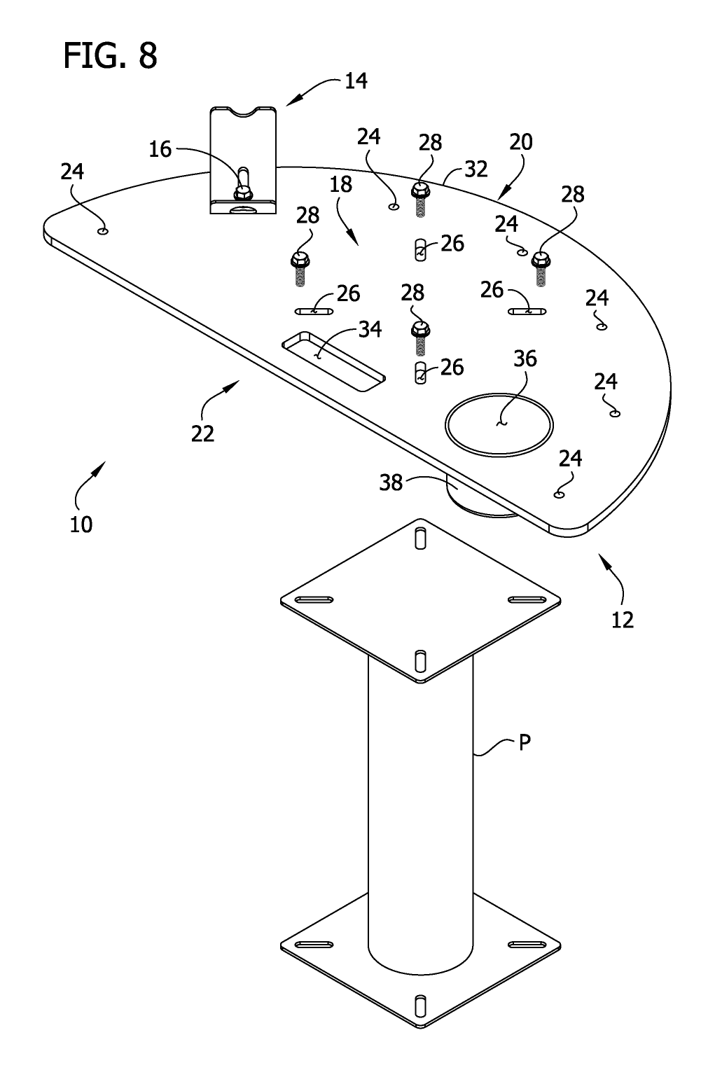

Referring to FIGS. 1-8, a fishing rod support system of an embodiment of the present invention is indicated generally at 10. The fishing rod support system 10 includes a fishing rod support platform 12, a fishing rod holder 14, and a fastener 16 for securing the fishing rod holder to the platform. As will be discussed in greater detail below, the illustrated fishing rod support system 10 mounts to a pedestal or other support bracket and supports one or more fishing rods at user-selectable angles.

The fishing rod support platform 12 comprises a central portion 18, a generally arcuate end 20, and a generally straight end 22 extending between opposite terminations 20A, 20B of the generally arcuate end. In the illustrated embodiment, seven fishing rod holder-mounting apertures 24 are spaced angularly at the generally arcuate end 20 of the platform 12. However, it should be understood that other numbers of fishing rod holder-mounting apertures can also be used without departing from the scope of the invention. Four pedestal-mounting apertures 26 are arranged at four corners of a square shape at the central portion 18 of the platform 12. Other numbers and arrangements of pedestal-mounting apertures can also be used. In suitable embodiments, the number and arrangement of pedestal-mounting apertures are chosen to align with a bracket of a pedestal or other support on which the fishing rod support system 10 is to be mounted. Each of the pedestal-mounting apertures 26 is configured to receive a fastener 28 to secure the platform to a pedestal P (FIG. 7). The plurality of fishing rod holder-mounting apertures 24 are sized to receive fasteners 16 for securing fishing rod holders such as the rod holder 14 to the platform 12.

In a suitable embodiment, the fishing rod support platform 12 is made of a rigid plastic material and has a generally uniform thickness of about ⅜ inches. Other thicknesses and materials can also be used without departing from the scope of the invention.

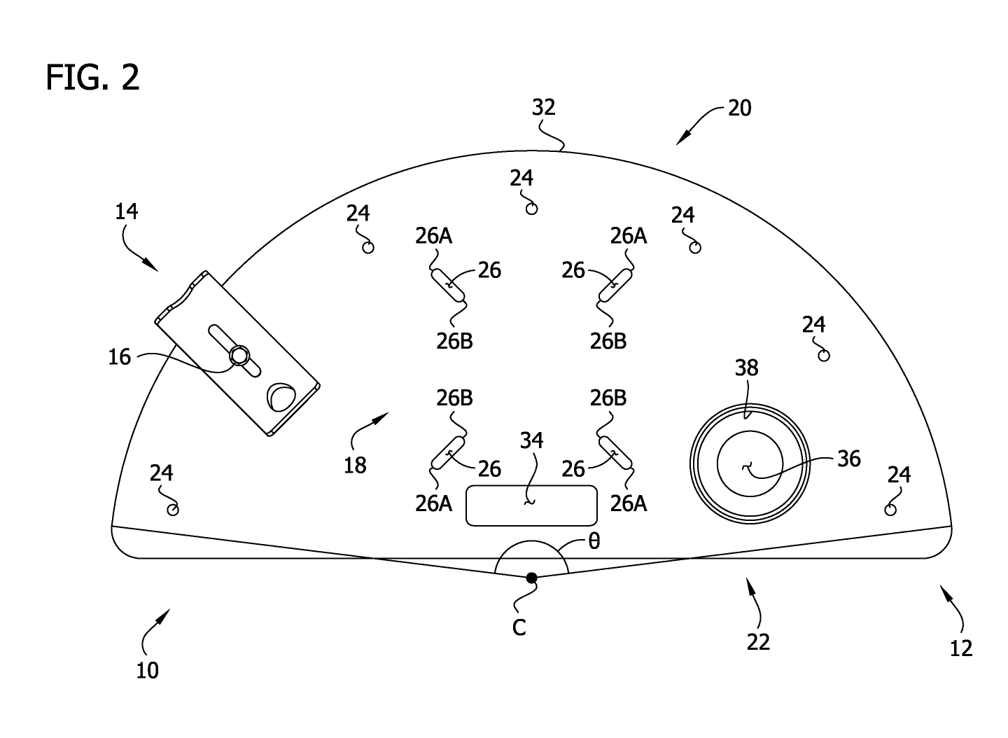

As shown, for example, in FIG. 2, the generally arcuate end 20 of the illustrated fishing rod support platform 12 has a substantially circular arc shape having a circle center C. The circle center C corresponds with the center point of a circle whose circumference aligns with the arcuate end 20. The circular arc shape of the arcuate end 20 subtends an angle θ. In suitable embodiments of a fishing rod support platform, the circular arc shape of a generally arcuate end subtends an angle θ0 with the circle center of between about 120° and about 240°. Other angles can also be used without departing from the scope of the invention. The fishing rod holder-mounting apertures 24 are spaced apart at substantially equal angular dimensions (e.g., between about 9° and about 60°, or between about 18° and about 36°). The generally arcuate end 20 of the platform 12 has a generally arcuate edge 32. The fishing rod holder-mounting apertures 24 are spaced radially inward of the generally arcuate edge 32. In suitable embodiments, fishing rod holder-mounting apertures are spaced radially inward of a generally arcuate edge of a fishing rod support platform a dimension of between about 1 inches and about 3 inches. However, it should be understood that other spacing dimensions can also be chosen without departing from the scope of the invention.

In the illustrated embodiment, each of the four pedestal-mounting apertures 26 comprises an elongate slot. As mentioned above, the pedestal-mounting apertures 26 are arranged in at the corners of a square shape. The slots 26 extend from an outer end 26A located in a corner of the square shape, toward a center of the square shape, to an inner end 26B spaced apart from the center of the square shape. As shown in FIG. 7, the four pedestal-mounting apertures 26 are positioned to align with four apertures in the mounting bracket of a boat seat pedestal P. In the illustrated embodiment, each of the four pedestal-mounting apertures comprises a slot length of about 1 inch and a slot width of about ⅜ inches. Outer ends 26A of adjacent slots 26 are spaced apart about 6 inches.

As shown in FIGS. 1-8, the fishing rod support platform 12 includes a handle aperture 34. In the illustrated embodiment, the handle aperture is sized to receive the hand of a user for grasping and maneuvering the platform 12. A cup holder aperture 36 is also disposed in the platform 12. In the illustrated embodiment, the cup holder aperture 36 has received a cup holder 38 sized for receiving a beverage can, cup, and/or bottle.

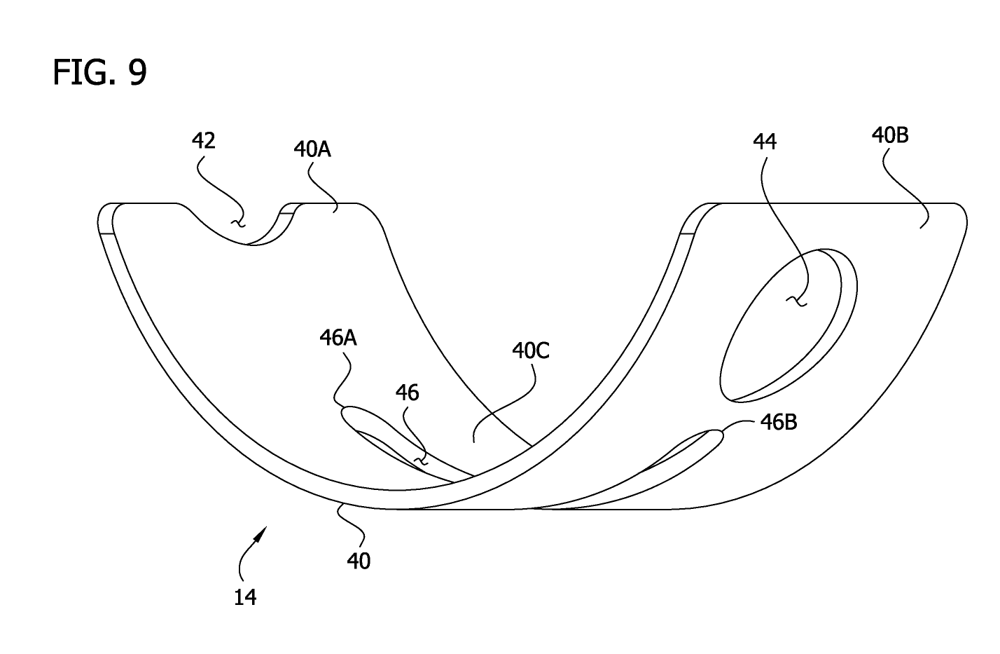

Referring to FIG. 9, the fishing rod holder 14 includes a semiannular body 40 with a front end 40A, a rear end 40B, and a central portion 40C. A notch 42 is disposed in the front end 40A of the semiannular body 40 and configured to support a medial portion of a fishing rod. A hole 44 is disposed in the rear end 40B of the semiannular body 40 and configured to receive and support a butt portion of a fishing rod. A mounting slot 46 is disposed in the central portion 40C of the semiannular body 40. The mounting slot 46 has a length extending from a front end 46A adjacent the notch 42 to a rear end 46B adjacent the hole 44. The mounting slot 46 also has a width sized for receiving the fastener 16 for securing the fishing rod holder 14 to a support surface such as the fishing rod support platform 12. The mounting slot 46 is sized such that the fastener 16 is slidable in the slot to secure the fishing rod holder 14 to the support surface (e.g., support platform 12) at any point along the length of the slot and thereby orient the semiannular body at any of a corresponding range of angles with respect to the support surface. In suitable embodiments the semiannular body 40 has a generally uniform thickness. In the illustrated embodiment, the fishing rod holder of claim 19 is one-half of an annular body (i.e., a half-ring shape) that has an internal diameter of about 6 inches. However, the semiannular body can have other shapes and other dimensions without departing from the scope of the invention. That is, in one respect, it is “semiannular” in the sense that it constitutes an open or incomplete annulus, for example between a one-third and two-thirds annulus; and it is not necessarily precisely one-half of an annulus. In preferred embodiments, the fishing rod holder comprises a material selected from the group of materials consisting of polyvinyl chloride and other rigid plastics. However, other materials can also be used without departing from the scope of the invention.

Referring again to FIGS. 1-8, it can be seen that a plurality of fishing rod holders 14 (up to seven in the illustrated embodiment) can be mounted to the fishing rod support platform 12 at the fishing rod holder-mounting apertures 24. Though in preferred embodiments the fishing rod holders 14 are used in the system 10, in other embodiments, other fishing rod holder embodiments can be used without departing from the scope of the invention. In the illustrated embodiment, the fasteners 16 are sized to extend through the mounting slot 46 of the fishing rod holder 14 and the selected one of the plurality of fishing rod holder-mounting apertures 24 in the platform 12 to secure the fishing rod holder to the platform. When a plurality of fishing rod holders 14 are desired to be used with the system 10, a plurality of fasteners 16 are provided and used to secure the holders to the platform 12 at the selected fishing rod holder-mounting apertures 24. When a fishing rod holder 14 is used with the system 10, the arcuate outer surface of the semi-annular body 40 contacts the flat top surface of the platform 12. The holders are selectively securable to the platform 12 at any of a range of angles with respect to the platform that correspond with the relative position of a fastener 16 in the mounting slot 46.

As will be appreciated by those skilled in the art, the fishing rod support system 12 is substantially versatile in securing fishing rods to a support. The platform 12 can be secured to a support such as a pedestal. Between one and seven fishing rod holders 14 can be secured to the platform 12 at any of the fishing rod holder-mounting apertures 24. The user can select the angular position of the desired fishing rod holders relative to the circle center C of the arcuate edge 32 by choosing to mount the desired fishing rod holder(s) 14 at any selected one(s) of the fishing rod holder-mounting apertures 24. Moreover, the angle of each fishing rod holder 14 with respect to the platform 12 can also be chosen by the user, for example, by selecting a location along the length of the slot 46 at which the fastener 16 should secure the holder to the platform. The respective angles can be chosen so that a fishing rod mounted in a fishing rod holder 14 avoids obstacles or positions a fishing line in a desired position.

One embodiment of a method of making a fishing rod holder 14 begins by cutting circular tubing orthogonal to a longitudinal center axis of the tubing to form a (relatively short) length of circular tubing (e.g., having a tube length of between about 1 inches and about 6 inches). Subsequently the length of tubing is cut crosswise (e.g., diametrically) to form a semiannular body 40 having front and rear ends 40A, 40B and a central portion 40C extending therebetween (If the semiannular body 40 is chosen to be substantially one-half an annular body, this cutting step produces a pair of suitable semiannular bodies.). A notch 42 is cut in the front end 40A of the semiannular body, and a hole 44 is cut in the rear end 40B of the semiannular body. A mounting slot 46 is cut in the central portion of the semiannular body having a length extending from a front end adjacent the notch to a rear end adjacent the hole and a width sized for receiving a fastener.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fishing rod support platform comprising:
a central portion;
a generally arcuate end;
a plurality of fishing rod holder-mounting apertures spaced angularly at the generally arcuate end of the platform; and
a pedestal-mounting aperture at the central portion of the platform;
wherein the pedestal-mounting aperture is configured to receive a fastener to secure the platform to a pedestal and wherein the plurality of fishing rod holder-mounting apertures are sized to receive fasteners for securing fishing rod holders to the platform.

2. The fishing rod support platform of claim 1 wherein the generally arcuate end has a substantially circular arc shape having a circle center.

3. The fishing rod support platform of claim 2 wherein the circular arc shape subtends an angle with the circle center between about 120° and about 240°.

4. The fishing rod support platform of claim 1 wherein the plurality of fishing rod holder-mounting apertures are spaced apart at substantially equal angular dimensions about the circle center.

5. The fishing rod support platform of claim 4 wherein the plurality of fishing rod holder-mounting apertures comprises between five and nine fishing rod holder-mounting apertures.

7. The fishing rod support platform of claim 5 wherein the plurality of fishing rod holder-mounting apertures comprises seven fishing rod holder-mounting apertures.

8. The fishing rod support platform of claim 4 wherein the generally arcuate end comprises a generally arcuate edge and wherein the plurality of fishing rod holder-mounting apertures are spaced radially inward of the generally arcuate edge.

9. The fishing rod support platform of claim 8 wherein the fishing rod holder-mounting apertures are spaced radially inward of the generally arcuate edge a dimension of between about 1 inches and about 3 inches.

10. The fishing rod support platform of claim 1 wherein the platform comprises four pedestal-mounting apertures arranged in a square shape at the central portion of the platform.

11. The fishing rod support platform of claim 10 wherein each of the four pedestal-mounting apertures comprises an elongate slot extending from an outer end located in a corner of the square shape toward a center of the square shape to an inner end spaced apart from the center of the square shape.

12. The fishing rod support platform of claim 11 wherein the four pedestal-mounting apertures are positioned to align with four apertures in a boat seat pedestal mounting bracket.

13. The fishing rod support platform of claim 11 wherein each of the four pedestal-mounting apertures comprises a slot length of about 1 inch and a slot width of about ⅜ inches.

14. The fishing rod support platform of claim 1 further comprising a generally straight end extending between opposite terminations of the generally arcuate end.

15. A fishing rod support system comprising:
a platform comprising a central portion, a generally arcuate end, a plurality of fishing rod holder-mounting apertures spaced angularly at the generally arcuate end, and a pedestal-mounting aperture at the central portion, wherein the pedestal-mounting aperture is configured to receive a fastener for securing the platform to a pedestal;
a fishing rod holder; and
a fastener for securing the fishing rod holder to the platform at a selected one of the plurality of fishing rod holder-mounting apertures.

16. The fishing rod support system of claim 15 wherein the fishing rod holder further comprises a mounting slot and wherein the fastener is sized to extend through the mounting slot and the selected one of the plurality of fishing rod holder-mounting apertures to secure the fishing rod holder to the platform.

17. The fishing rod support system of claim 15 wherein the fishing rod holder is one of a plurality of fishing rod holders in the fishing rod support system.

18. The fishing rod support system of claim 17 wherein the system comprises a plurality of fasteners in the fishing rod support system for securing the plurality of fishing rod holders to the platform at a selected plurality of the fishing rod holder-mounting apertures.

19. The fishing rod support system of claim 17 wherein the fishing rod holder comprises a semiannular outer surface.

20. The fishing rod support system of claim 24 wherein the fishing rod holder is configured to be selectively securable to the platform at any of a range of angles with respect thereto and such that the outer surface of the rod holder contacts platform.
